(19) United States
(12) Patent Application Publication
(10) Pub. No.: US 2025/0077176 A1
(43) Pub. Date: Mar. 6, 2025

(54) ENVIRONMENT DISPLAY DEVICE

(71) Applicant: Pierre Huambachano, Simi Valley, CA (US)

(72) Inventor: Pierre Huambachano, Simi Valley, CA (US)

(21) Appl. No.: 18/817,947

(22) Filed: Aug. 28, 2024

Related U.S. Application Data
(60) Provisional application No. 63/536,045, filed on Aug. 31, 2023.

(51) Int. Cl. G06F 3/16; H04R 1/02

(52) U.S. Cl. CPC G06F 3/167; H04R 1/028; H04R 2499/15

(57) ABSTRACT

An environment display device, including a display unit capable of displaying an object thereupon, a microphone disposed on at least a portion of the display unit to receive at least one audio input, and a control unit to process the audio input and control the display unit to display the object on the display unit, such that the displayed object corresponds to the audio input received by the microphone based on results found during an Internet search automatically conducted by the control unit in response to the received audio input.

### CROSS-REFERENCE TO RELATED APPLICATIONS

This application claims priority under 35 USC § 120 from U.S. Provisional Application No. 63/536,045, entitled “Environment Display Device,” which was filed on Aug. 31, 2023, in the United States Patent and Trademark Office, the disclosure of which is incorporated herein in its entirety by reference.

### BACKGROUND

### 1. Field

The present general inventive concept relates generally to a display, and particularly, to an environment display device.

### 2. Description of the Related Art

Most display units, such as computer monitors, televisions, and/or phones show content based on a program. For example, computer monitors and/or phones will display content that is programmed on the phone and/or visible from an online website. Similarly, televisions display content based on a television network, a cable provider, and/or a satellite provider.

However, the aforementioned display units are limited to specific content and/or depend on a third-party source of content. Currently, artificial intelligence (AI) is developing rapidly, but has not been integrated into any type of display unit. Moreover, the display units cannot rely on Al to generate content for its users.

Therefore, there is a need for an environment display device that uses Al to generate an environment for display.

### SUMMARY

The present general inventive concept provides an environment display device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an environment display device, including a display unit capable of displaying an object thereupon, a microphone disposed on at least a portion of the display unit to receive at least one audio input, and a control unit to process the audio input and control the display unit to display the object on the display unit, such that the displayed object corresponds to the audio input received by the microphone based on results found during an Internet search automatically conducted by the control unit in response to the received audio input.

The display unit may be a mirror to reflect at least one of an environment, a person, and an object while the display unit is turned off.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of an environment display device, according to an exemplary embodiment of the present general inventive concept; and

FIG. 2 illustrates a zoomed in view of the environment display device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Environment Display Device 100
Display Unit 110
Control Unit 120
Communication Unit 130
Microphone 140
Speaker 150
Light 160
Frame 170
Power Source 180

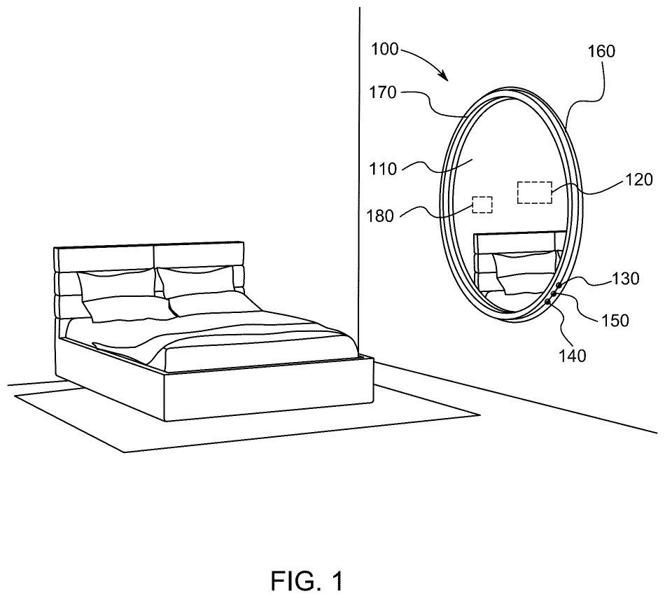

FIG. 1 illustrates a side perspective view of an environment display device 100, according to an exemplary embodiment of the present general inventive concept.

The environment display device 100 may be constructed from at least one of metal, plastic, wood, glass, and rubber, etc., but is not limited thereto.

The environment display device 100 may include a display unit 110, a control unit 120, a communication unit 130, a microphone 140, a speaker 150, a light 160, a frame 170, and a power source 180, but is not limited thereto.

Referring to FIG. 1, the display unit 110 is illustrated to have an oval shape. However, the display unit 110 may be rectangular, circular, triangular, pentagonal, hexagonal, heptagonal, octagonal, or any other shape known to one of ordinary skill in the art, but is not limited thereto.

The display unit 110 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 110 may display content thereon. For example, the display unit 110 may display an environment scene, such as a mountain top, outer space, a rain storm, a beach, and/or a city skyline. Additionally, the display unit 110 may be a mirror. In other words, the display unit 110 may reflect an environment, a person, and/or an object while the display unit 110 is turned off.

The control unit 120 may include an input unit, a processing unit, and a storage unit, but is not limited thereto.

The input unit of the control unit 120 may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

Also, the display unit 110 may be combined with the input unit to be a touch-screen.

The processing unit of the control unit 120 (or central processing unit, CPU) may include electronic circuitry to carry out instructions of a computer program by performing basic arithmetic, logical, control and input/output (I/O) operations specified by the instructions. The processing unit of the control unit 120 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 120 may also include a microprocessor and a microcontroller.

The storage unit of the control unit 120 may include a random access memory (RAM), a read-only memory (ROM), a hard disk, a flash drive, a database connected to the Internet, cloud-based storage, Internet-based storage, or any other type of storage unit.

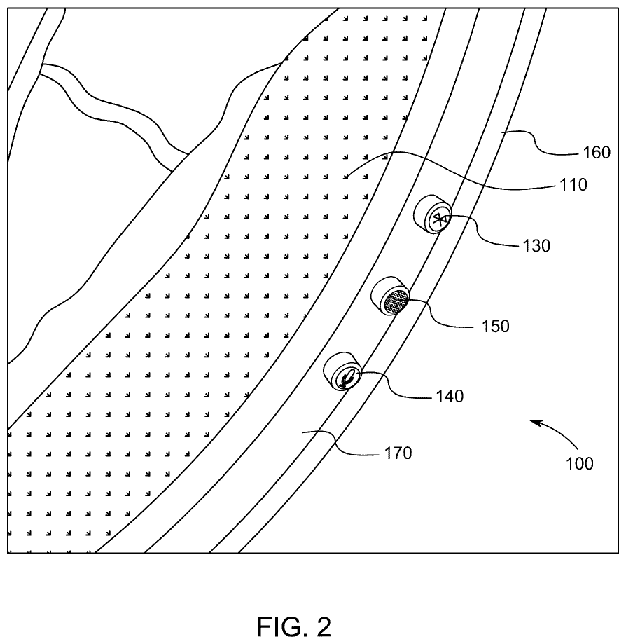

FIG. 2 illustrates a zoomed in view of the environment display device 100, according to an exemplary embodiment of the present general inventive concept.

The communication unit 130 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The control unit 120 may be disposed within at least a portion of the display unit 110. The control unit 120 may access the Internet via the communication unit 130 to allow at least one user to access a website, and/or may allow a mobile application and/or a software application to be executed using the processing unit of the control unit 120. For ease of description, the mobile application and/or the software application will be hereinafter referred to as an app. The app may be downloaded from the Internet, such as on the storage device of the control unit 120.

The control unit 120 executing the app may operate as an artificial intelligence (AI) program. More specifically, the control unit 120 executing the app may determine the content to be displayed on the display unit 110.

Moreover, the communication unit 130 may be disposed on at least a portion of the display unit 110. The communication unit 130 may receive a connection (e.g., a wireless connection) thereon from an external device, such as a mobile device, a cell phone, a tablet computer, a desktop computer, a laptop computer, and/or any other computing device. The communication unit 130 may transmit data from the external device for processing by the control unit 120. For example, the communication unit 130 may transmit a command to display the mountain top on the display unit 110 from the external device.

The microphone 140 may be disposed on at least a portion of the display unit 110. The microphone 140 may receive at least one audio input (e.g., a voice command) therein. The microphone 140 may transmit the at least one audio input to the control unit 120 for processing. The display unit 110 may update and/or change the content displayed thereon in response to the at least one audio input received by the microphone 140.

For example, the microphone 140 may receive the at least one audio input to generate the mountain top and/or the outer space. Subsequently, the control unit 120 may randomly generate the mountain top and/or the outer space to be displayed on the display unit 110. Moreover, the control unit 120 executing the app may continuously learn via the Al program. Therefore, the control unit 120 may navigate over the Internet using the communication unit 130 to learn about other types of content, such as different mountains, different outer space views, different beaches, etc. As such, the display unit 110 may display different content each time the environment scene is requested. For example, the display unit 110 may display Mount Everest on a first request for the mountain top. Thereafter, the display unit 110 may display Mount St. Helens on a second request for the mountain top.

Furthermore, the control unit 120 may perform additional functions. The control unit 120 may identify time by displaying the time on the display unit 110, set an alarm, provide weather updates, and/or manage a personal planner in response to the microphone 140 receiving a request to display time, a request to set an alarm, a request for a weather update, and/or a request for a personal planner, respectively. The control unit 120 may also adjust and/or change based on new applications that are developed.

The speaker 150 may be disposed on at least a portion of the display unit 110. The speaker 150 may emit at least one audio output therefrom. For example, the speaker 150 may emit music to accompany the content in response to the display unit 110 displaying the environment scene. Also, the speaker 150 may emit the at least one audio output that speaks words to identify the time, the weather update, the alarm, and/or the personal planner.

The light 160 may be circumferentially disposed on at least a portion (e.g., around a perimeter) of the display unit 110. The light 160 may illuminate in response to a request for light received by the microphone 140. Alternatively, the light 160 may turn on in response to tapping the display unit 110 a predetermined number of times (e.g., twice, three times) a first time. Conversely, the light 160 may turn off in response to tapping the display unit 110 the predetermined number of times a second time. As such, the light 160 may operate as a night light. Additionally, the light 160 may randomly change color in response to commands received from the control unit 120.

The frame 170 may be circumferentially disposed around a perimeter of the display unit 110. The frame 170 may form a border around the display unit 110.

The power source 180 may include a power inlet, a battery, and a solar cell, but is not limited thereto.

The power source 180 may be disposed within at least a portion of the display unit 110. The power source 180 may provide power to the display unit 110, the control unit 120, the communication unit 130, the microphone 140, the speaker 150, and/or the light 160.

Therefore, the environment display device 100 may use the control unit 120 running the Al to generate a display of the environment scene. Also, the environment display device 100 may learn over time to create more content for future requests of content.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An environment display device, comprising:
a display unit capable of displaying an object thereupon;
a microphone disposed on at least a portion of the display unit to receive at least one audio input; and
a control unit to process the audio input and control the display unit to display the object on the display unit, such that the displayed object corresponds to the audio input received by the microphone based on results found during an Internet search automatically conducted by the control unit in response to the received audio input.

2. The environment display device of claim 1, wherein the display unit is a mirror to reflect at least one of an environment, a person, and an object while the display unit is turned off.
